(19) United States
(12) Patent Application Publication
(10) Pub. No.: US 2009/0088907 A1
(43) Pub. Date: Apr. 2, 2009

(54) MODULAR ELECTRICAL GRID INTERFACE DEVICE

(75) Inventors: Karl LEWIS, Great Falls, VA (US); Brian Golden, Great Falls, VA (US)

Correspondence Address: GREENBERG TRAURIG, LLP, 2101 L Street, N.W., Suite 1000, Washington, DC, 20037, US

(73) Assignee: GridPoint, Inc., Arlington, VA (US)

(21) Appl. No.: 12/243,796

(22) Filed: Oct. 1, 2008

Related U.S. Application Data
(60) Provisional application No. 60/976,495, filed on Oct. 1, 2007.

(51) Int. Cl. G06F 1/32; G06F 1/28

(52) U.S. Cl. 700/286

(57) ABSTRACT

A smart grid gateway which includes a onboard computer programmed to provide load measurement and control of at least one local resource or asset. At least one metrology module is configured to provide metering of the at least one local resource or asset. At least one LAN module is configured to communicate with the at least one local resource or asset. At least one WAN module is configured to communicate with a network operations center.

This application claims priority to U.S. Provisional Patent Application No. 60/976,495 filed on Oct. 1, 2007, which is incorporated by reference in its entirety herein. The disclosure of U.S. patent application Ser. No. 12/210,761 filed on Sep. 15, 2008 is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of electric power distribution, and in particular to methods and systems for electric power management.

### BACKGROUND OF THE INVENTION

The Advanced Metering Infrastructure (AMI) system has been proposed for measuring energy usage using advanced devices such as water meters, electric meters and gas meters, through various communication media on request or on a pre-defined schedule. However, instrumentation at the billing level is only a small part of a true smart grid solution. Sub metering is required to provide actionable information. Direct load control is required to meet peak management goals. Integration of distributed resources is required to optimize economic and environmental costs.

Furthermore, current AMI-based solutions for providing a smart grid are proprietary to vendor platforms. There is no flexibility for integrating best of breed technologies and there are few standards for defining interoperability. There is difficulty in deploying a mixed network of assets optimized for different situations. Communications media are proprietized to the meter, thereby preventing future proofing.

Current AMI-based solutions are also expensive and hard to justify across all rate-payer segments. A “one size fits all” approach does not work because of poor price equanimity. Current AMI-based solutions do not adequately define peak load growth curtailment that benefits all rate payers.

In addition, modularity and expandability in current AMI-based solutions is severely limited. Communications media will change within the asset life of the meter, thereby causing compatibility problems. Expansion into direct load control, distributed resource integration, value-added services requires multiple vendors providing plug-and-play interoperability.

### SUMMARY OF THE INVENTION

In one embodiment, the invention is a smart grid gateway which includes a onboard computer programmed to provide load measurement and control of at least one local resource or asset. At least one metrology module is configured to provide metering of the at least one local resource or asset. At least one LAN module is configured to communicate with the at least one local resource or asset. At least one WAN module is configured to communicate with a network operations center.

In another embodiment, the invention provides a smart grid management system that includes intelligent network asset control systems connected to a network, each controlling at least one asset on a power grid. A plurality of intelligent commercial building control systems are connected to the network, each controlling at least one commercial building device connected to the power grid. A plurality of intelligent residential control systems are provided, each controlling at least one residential device connected to the power grid. At least one utility operator console is connected to the network. The utility operator console is configured to control all of the intelligent control systems so as to enable a console operator to manage the supply of and demand for power on the power grid.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates one embodiment of the basic elements of a smart grid that provides advanced power management.

FIG. 2 illustrates one example of how a load duration curve can be reshaped by power consumption and storage management.

FIG. 3 illustrates one embodiment of a graph showing how a conventional power grid can be migrated to a smart grid.

FIG. 4 illustrates one embodiment of an open standards platform for managing resources on a power grid or at consumer locations.

FIG. 5 illustrates one embodiment of systems and interfaces for control and operation of a smart grid.

FIG. 6 illustrates one embodiment of a utility control console 600 which provides utilities with direct control over an intelligent network of distributed energy resources.

FIG. 7 illustrates one embodiment of a web-based consumer portal 700 that provides online energy management services.

FIG. 8 illustrates one embodiment of a power management appliance 800 that provides an intelligent smart grid gateway.

FIG. 9 illustrates one embodiment of a network 900 of intelligent control systems for providing smart grid management.

### DETAILED DESCRIPTION

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The invention provides a system for providing a smart electrical power distribution grid by pushing intelligence into the grid. In one embodiment, real time information can be provided to the point of consumption and distributed generation. In one embodiment, the system allows for autonomous reactions to network events to optimize reliability and economics.

The system may be used to reduce peak load by optimizing the economics of power generation and improving reliability by integrating distributed assets and resources, and providing demand reduction via direct load control of commercial and residential systems. The system can further provide energy storage at the point of consumption or within the electric grid. The system can further provide distributed generation via sources such as solar PV, micro-wind, standby generators, and Plug-In Electric Vehicles (PEVs.)

In one embodiment, the system further provides for integration of an economic analysis into distributed resource management. Such analysis includes, e.g., comparison of the cost of incremental generation to demand reduction, optimization of the arbitrage value of energy storage, and optimization of the generation portfolio to include distributed assets.

In one embodiment, the system further provides customers value-added products and services from the utility and its business partners. For example, online services can be provided to show detailed energy consumption. The system can be used to sell customers backup power as a service. The system can be used to show customers how to reduce consumption in concert with utility benefits. The system can provide the capability to sell/lease customers distributed generation systems like solar PV.

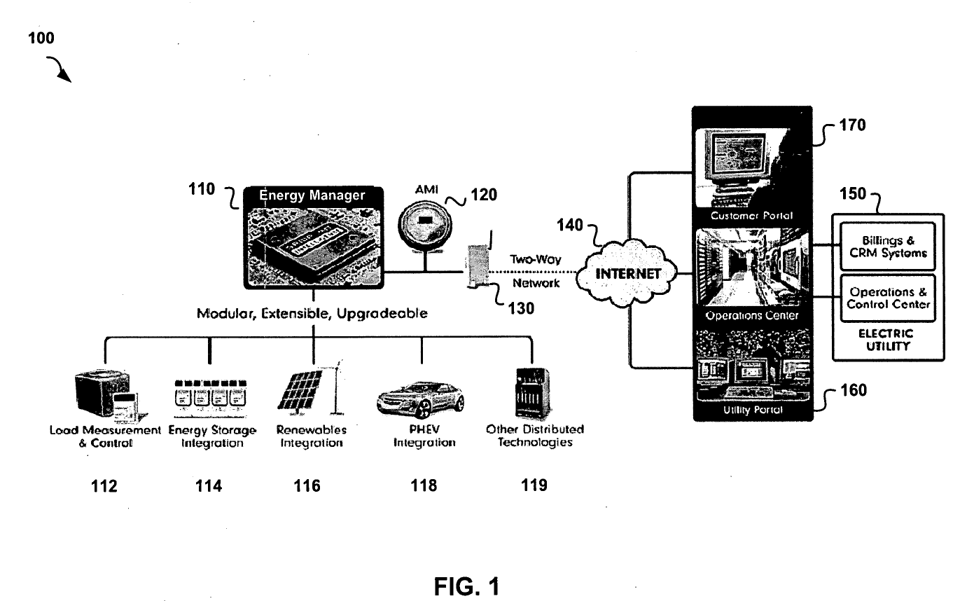

FIG. 1 illustrates one embodiment of the basic elements of a smart grid 100 that provides advanced power management. Power consumers, such as businesses and homeowners have one or more energy management appliances 110. The energy management appliances 110 can provide load measurement and control 112 services, integration, management and control of energy storage units 114 such as batteries, integration, management and control of renewable sources 116 such a solar power and wind power devices, 116, integration with plug-in electric vehicles (PEVs) 118 and integration with other distributed technologies 119. The energy management appliance 110 can communicate with one or more AMI (Advanced Metering Infrastructure) meters 120.

The energy management appliance 110 can further communicate, over an external network such as the Internet 140, with an electric utility operations and control center 150, and one or more customer portals 170. The electric utility operations and control center 150 hosts at least one control console displaying a utility portal 160 that can display data collected from energy management appliances 110 and other devices on the power grid. The utility portal 160 can further control devices, such as energy management appliances 110 on the grid by causing commands to be issued to the devices over the Internet 140. Individual power consumers can control devices such as energy management appliances 110 located at the consumer's home or business using a customer portal 170.

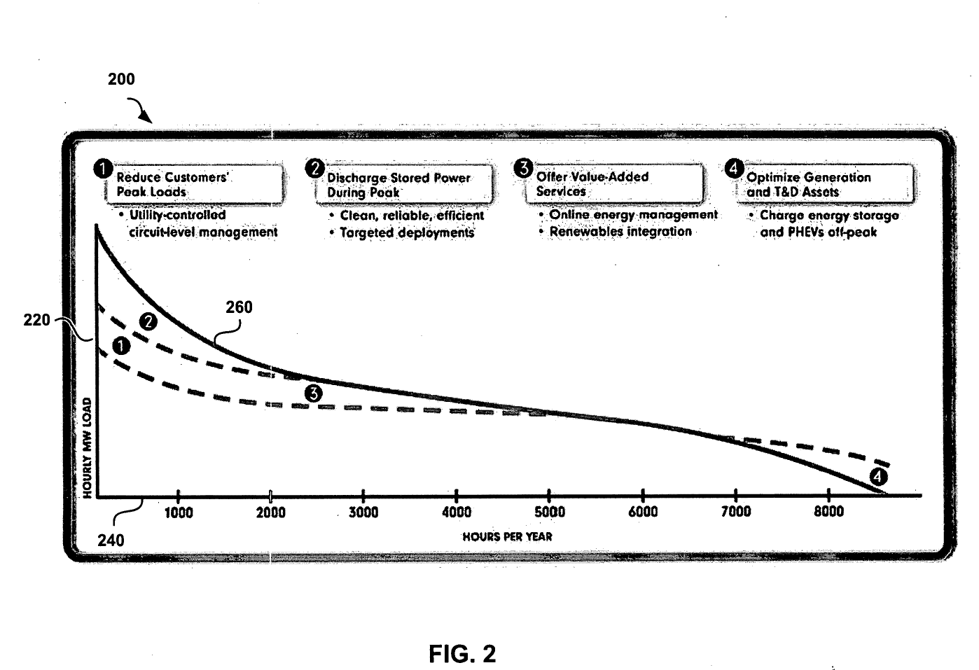

FIG. 2 illustrates one embodiment 200 of how a load duration curve can be reshaped by power consumption and storage management. The vertical axis of the graph 220 represents hourly MW load on a power grid. The horizontal axis 240 represents the number of hours per year any give hourly MW load is placed on the grid. One embodiment of a load duration curve 260 shows wide variations in demand, from heavy demand on the far left to light demand on the far right. Heavy demand periods are of concern to an entity managing a power grid, since at these times the power grid is at greatest risk of partial or total failure. Low demand periods are also of interest, since at these times, power consumption that can be scheduled for low consumption periods need not place demand on the power grid at peak load times.

An entity managing a power grid would, in many cases, like to flatten the load duration curve, ideally maintaining uniform demand on grid at all times, but more practically, lowering peak demand in high demand periods and using low demand periods for uses that can be flexibly scheduled. As shown in FIG. 2, one method a utility or other entity managing a power grid can use a smart power grid to flatten the load duration curve is by (1) reducing customer loads at peak demand times through utility controlled circuit level management at individual consumer locations. For example, a utility could reduce power supplied to pool pumps or air conditioning units.

The load duration curve can be further flattened using a smart power grid by (2) discharging stored energy during peak load times. Such stored energy can comprise, for example, batteries and capacitor banks. Such stored energy resources are clean, reliable, efficient and can be deployed in targeted locations (i.e. as close as possible to anticipated demand.) A smart grid can further provide (3) value added services to reduce demand on the power grid such as online energy management and integration of renewable energy sources, and (4.) optimal use of generation assets, and scheduling charging of energy storage devices and PEVs at times of minimum demand.

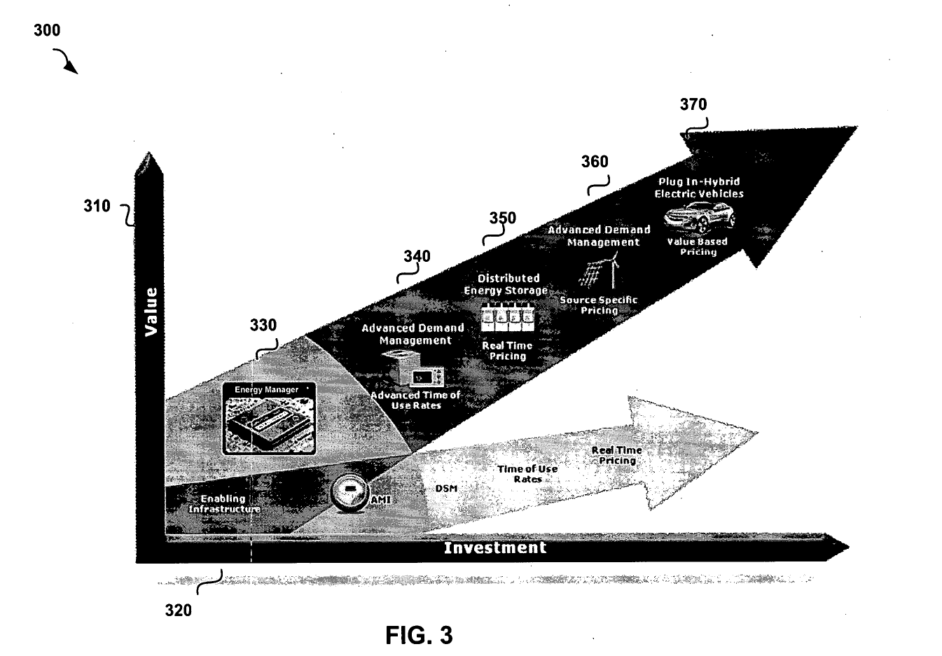

FIG. 3 illustrates one embodiment of a graph showing how a conventional power grid can be migrated to a smart grid. The vertical axis of the graph 310 represents value, which could be represent grid stability, optimum use of grid assets or decreased overall cost of power. The horizontal axis 320 represents investment over time. The migration process begins by installing an enabling infrastructure 330, which includes installing energy management appliances at consumer locations, as well as installing or upgrading meters and other devices to be compliant with AMI standards.

The next step in the migration path is to begin utilizing the enabling infrastructure to implement advanced demand management 340, for example, centralized control of individual consumer circuits and appliances based on demand on the power grid. In one embodiment, advanced demand management 340 includes advanced time of use rates. Distributed energy storage units under centralized control 350 can be installed to provide energy dispatch capabilities and real-time pricing can be initiated. Distributed renewable power generation units, such as, for example, solar panels, under centralized control 350 can be integrated to provide power generation capabilities and source specific pricing can be initiated. Management of charging plug-in hybrid electric vehicles 370 can additionally be provided.

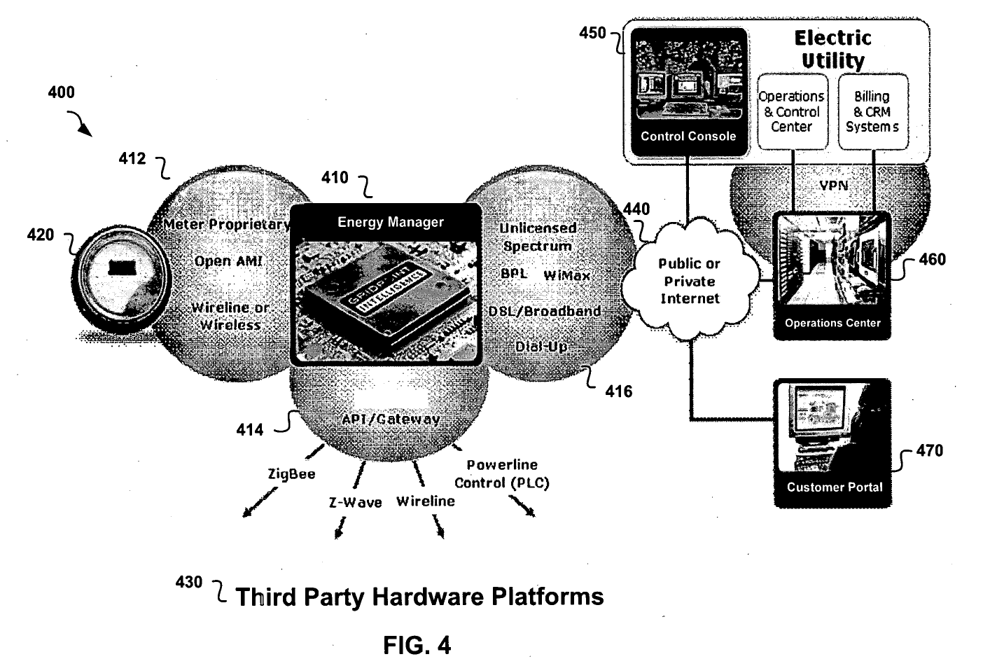

Given that devices relating to management of power grids, as well as consumer devices that measure, control, store or consume power may be manufactured by many different manufacturers, it is important for such devices to support open standards for ready interoperability. FIG. 4 illustrates one embodiment of an open standards platform for managing resources on a power grid or at consumer locations 400. In one embodiment of an energy management appliance 410, the appliance supports a variety of open standards interfaces 414 for communicating with third party devices 430, including ZigBee (communication protocols for small, low-power digital radios), Z-Wave (communications protocol for wireless products, especially consumer appliances), wireline (i.e. Plain Old Telephone Service (POTS)) and PLC (protocol for communicating over power lines.)

In one embodiment of an energy management appliance 410, the appliance further supports a variety interfaces 412 for communicating with meters 420 such as AMI, wireline as well as proprietary meter protocols, if needed. The energy management appliance 410 furthers support a variety of networking protocols 416 for communicating with various entities over public or private network 440, for example, a utility operations and control center, 450, a utility operations center 460 and customer portals 470. Networking protocols 416 supported by the energy management appliance 410 can include DSL/Broadband, WiMAX (Worldwide Interoperability for Microwave Access), BPL (Broadband over Power Lines, i.e. PLC for Internet access), dial-up, and RF communications using unlicensed spectrum.

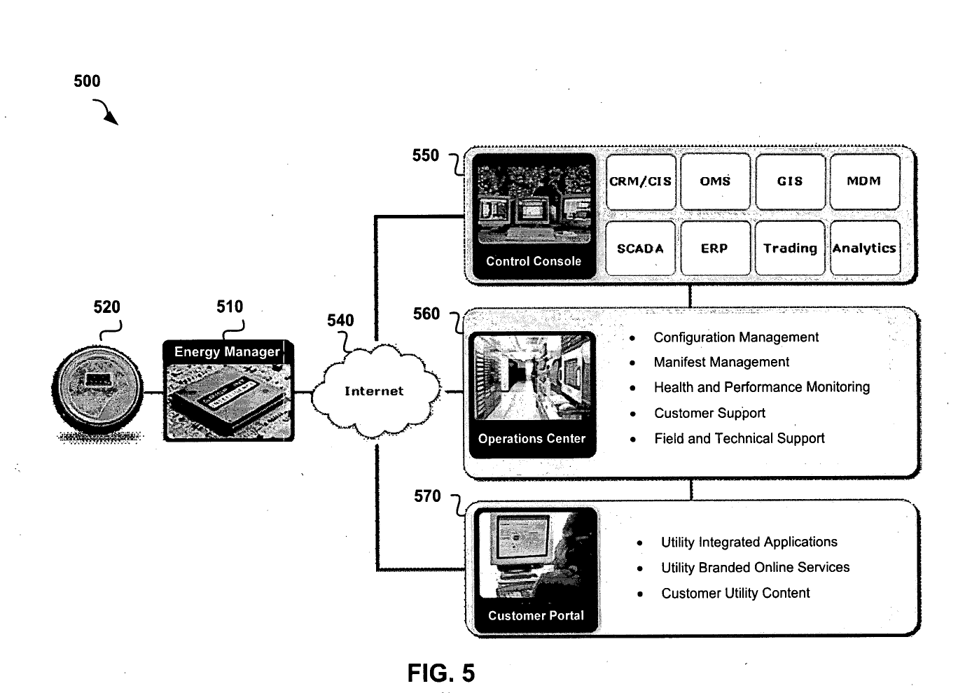

FIG. 5 illustrates one embodiment of systems and interfaces for control and operation of a smart grid 500. In the illustrated embodiment, the smart grid includes a plurality of energy management appliances 510 and meters 520 at various consumer locations. The energy management appliances 510 and meters 520 are connected over an external network such as the Internet 540 to a utility control center 550, a utility operations center 560, and to a plurality of customer portals 570. The utility control center 550 hosts an array of systems for overall management of the utility's business. Such systems can include CRM/CIS (Customer Relationship Management systems), OMS (Outage Management Systems), GIS (Geographic Information Systems), MDM (Meter Data Management systems), SCADA (Supervisory Control And Data Acquisition systems), ERP (Enterprise Resource Planning systems), Energy Trading systems, and Analytics systems.

The utility operations center 560 provides configuration management of the power grid, manifest management, power grid health & performance metering, customer support, and technical and field support. The customer portals 570 provide interfaces that allow consumers to monitor and control power consumption at consumer locations. The portals can include utility integrated applications, utility branded online services, and customer utility content.

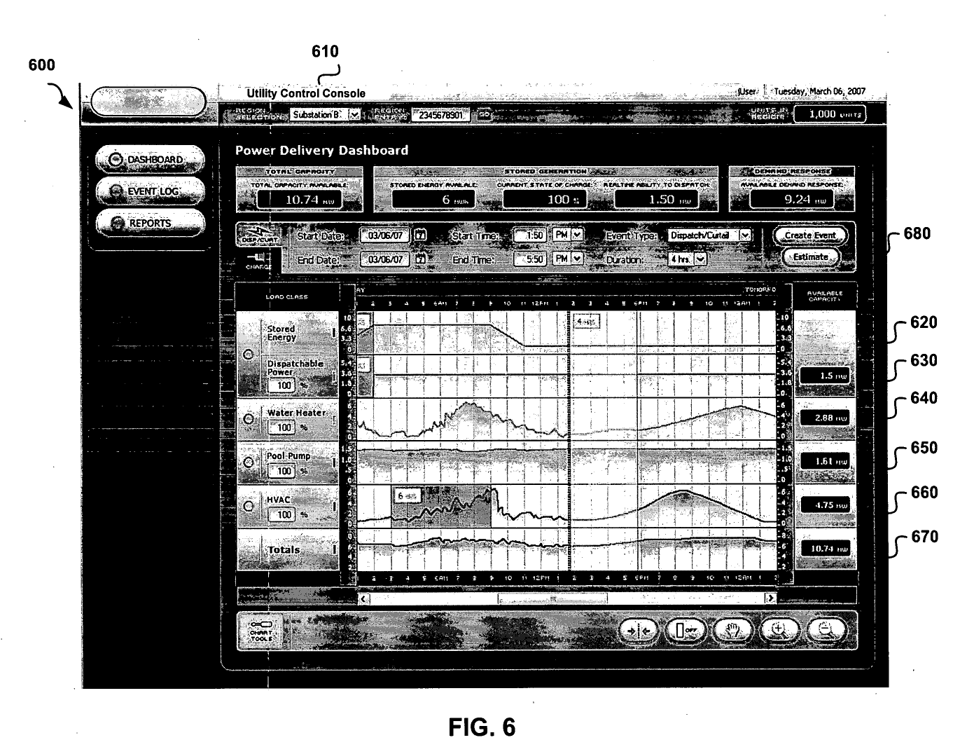

FIG. 6 illustrates one embodiment of a utility control console 600 which provides utilities with direct control over an intelligent network of distributed energy resources. The console 600 can be used by the utility, inter alia, at the utility's control center, the utility's operation center, or both. One embodiment of such a control console is detailed in U.S. Patent Application No. 60/878,072 entitled “Utility Console for Controlling Aggregated Energy Resources” filed Jan. 3, 2007, which is incorporated herein by reference. In one embodiment, the control console provides on-demand or scheduled peak event management, the ability to predict available capacity of stored energy, load control and distributed generation. The console can provide information before, during and after a peak management event, and can be integrated with utility operations environment.

In the embodiment illustrated in FIG. 6, the console provides a display that can select and manage a portion of a grid associated with a specific substation 610. The console provides a display that shows total stored energy 620, as well as immediately dispatchable power 630. The console further displays current and predicted power consumption for power consumption classes including water heaters 640, pool pumps 650, HVAC 660. The console further displays total current and predicted total power consumption 670. The console further provides an event creation bar 670 that allows the utility to create events (immediate executed or scheduled in the future) to manage the power grid, including immediate or scheduled reductions in power consumption within a consumption class, as well as immediate or scheduled dispatch of stored power to the grid.

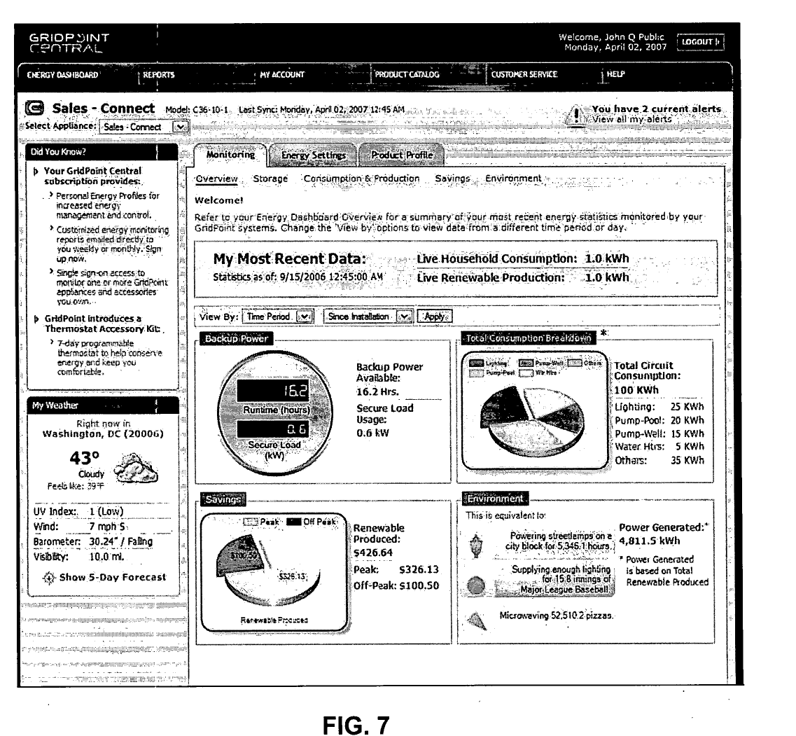

FIG. 7 illustrates one embodiment of a web-based consumer portal 700 that provides online energy management services. Such portal is described in detail in U.S. Provisional Patent Application Ser. No. 60/971,938 entitled User Interface For Demand Side Energy Management filed Sep. 13, 2007, which is incorporated herein by reference. In one embodiment, the portal Provides detailed consumption and conservation data to consumers, and provides a personal energy profile that can be used to automatically optimize energy consumption. The portal can also be used as the consumer's interface to online services that provide information such as energy savings data, detailed production and consumption data, utility rate schedules, and environmental benefits.

In the embodiment illustrated in FIG. 7, the portal provides notices and announcements 710, current weather conditions 720, and a set of tabs 730 for monitoring, energy settings, and product profiles. The monitoring tab is displayed, and provides an available backup power meter 740, a total consumption breakdown pie chart 750, a total savings pie chart for peak and off peak consumption 760, and environmental information 770 including generated energy.

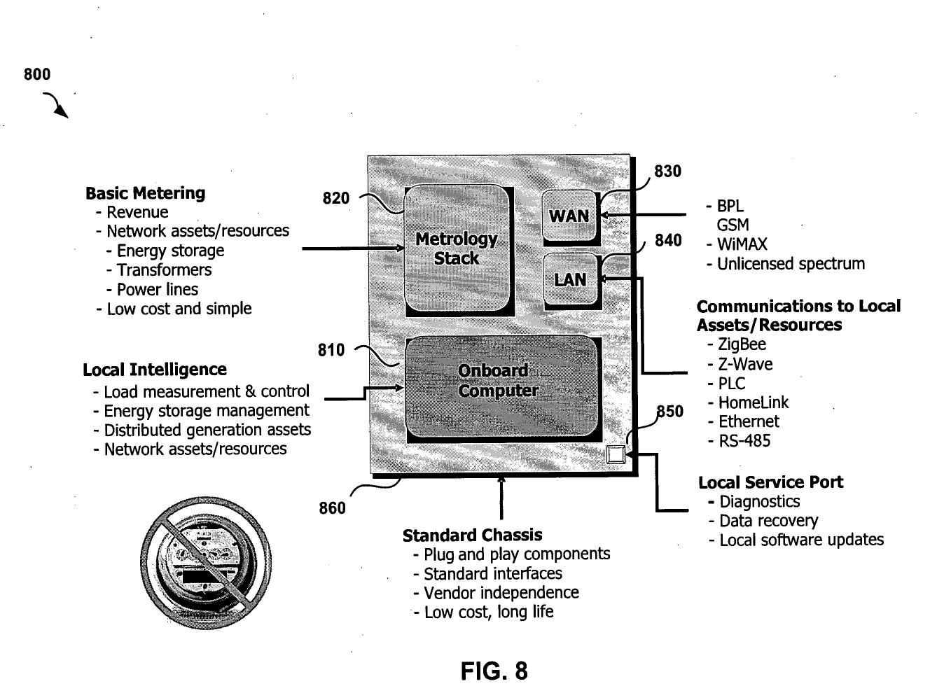

FIG. 8 illustrates one embodiment of a power management appliance 800 that provides an intelligent smart grid gateway. The gateway provide a “future-proof” entry point into a smart grid through new “behind the meter” applications, the ability to adapt to changes in public and private carrier networks, and the utilization of differentiated amortization schedules. The gateway further provides for vendor independence by using an open platform to eliminate vendor proprietary systems. The invention can utilize “plug and play” best-of-breed components to provide standards-based interoperability, thereby driving down cost and driving up quality.

In the embodiment illustrated in FIG. 8, the smart grid gateway 800 comprises a programmable onboard computer and memory 810, at least one metrology module 820, at least one WAN module 830, at least one LAN module 840, and a local services port 850, all housed in a standard chassis 860. The onboard computer 810 is programmed with computer software to control local resources and provides load measurement and control, energy storage management, management of distributed generation assets, and management of network assets and resources. The at least one metrology module 820 is configured to provide a metrology stack and support for basic metering, revenue computation, and metering for network assets and resources such as energy storage devices, transformers, and power lines.

The at least one WAN module 830, the at least one LAN module 840, and the at least one metrology module 820 utilize a standard interface to interoperate with the onboard computer 810. In one embodiment, the standard chassis 860 contains multiple interfaces for WAN modules 830, multiple interfaces for LAN modules, and multiple interfaces for metrology modules.

The at least one WAN module 830 is configured to communicate with a network operations center using standard WAN protocols such as BPL, GSM, WiMAX, and unlicensed spectrum RF. The at least one LAN module 840 is configured to communicate with local assets and resources using standard protocols such as ZigBee, Z-Wave, PLC, HomeLink, Ethernet, or RS-485 Modbus. The local service port 850 permits service personnel to run diagnostics, data recovery, and local software updates on the gateway 800. Alternatively, the smart grid gateway can be configured to permit service personnel to run diagnostics, data recovery, and local software updates on the gateway via a LAN connection provided by the LAN module 840 or via a WAN connection provided by the WAN module 850.

The standard chassis 860 is configured to support plug and play components and other standard hardware interfaces. The gateway may provide many applications in a single chassis, including residential metering, commercial metering, sub metering, demand management, distributed generation management, substation asset instrumentation with or without autonomous control, and network asset instrumentation within context of Smart Grid.

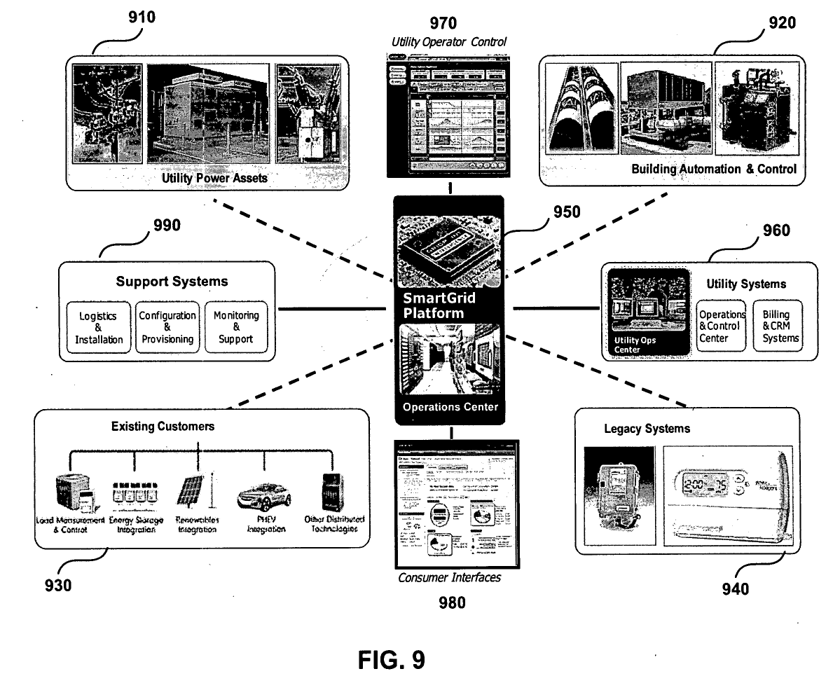

FIG. 9 illustrates one embodiment of a network 900 of intelligent control systems for providing smart grid management. Utility power assets 910 such as powerlines, transformers, capacitors and generators can be managed an controlled by intelligent control systems. Intelligent commercial building automation and control systems 920 can manage and control building air conditioning, elevators, and generators. Intelligent residential systems 930 can control residential air conditioners, energy storage devices such as batteries, renewable energy sources such as solar power or wind power, and the charging of PEVs. All of the intelligent control systems 910, 920 and 930, along with legacy DSM (Demand Side Management) systems 940 can be connected through the Internet to through a smart grid platform 950 a utility control and operations center 960 allowing the utility to control network resources using a utility operator console 970. Consumers are also able to control their own energy resources and loads through consumer interfaces 980.

While the invention has been particularly shown and described with reference to preferred embodiments thereof, it will be understood by those skilled in the art that various changes in form and details may be made therein without departing from the spirit and scope of the invention.

1. A smart grid gateway comprising:
an onboard computer configured to provide measurement or control of at least one local resource or asset;
at least one metrology module operatively connected to the onboard computer, wherein the at least one metrology module is configured to provide metering of the at least one local resource or asset at least one LAN module operatively connected to the onboard computer, wherein the at least one LAN module is configured to communicate with the at least one local resource or asset;
at least one WAN module operatively connected to the onboard computer, wherein the WAN module is configured to communicate with a network operations center.

2. The smart grid gateway of claim 1 wherein the components of the gateway are housed in a standard chassis configured to support plug and play components.

3. The smart grid gateway of claim 1 wherein the standard chassis provides a plurality of WAN module interfaces, a plurality of LAN module interfaces, and a plurality of metrology module interfaces.

4. The at least one WAN module, the at least one LAN module, and the at least one metrology module utilize a standard interface to interoperate with the onboard computer.

5. The smart grid gateway of claim 1 wherein the onboard computer is configured to provide measurement and control of at least one local resource or asset;.

6. The smart grid gateway of claim 1 additionally comprising a local service port configured to permit service personnel to run diagnostics, data recovery, and local software updates on the gateway.

7. The smart grid gateway of claim 1 wherein the smart grid gateway is configured to enable service personnel to run diagnostics, data recovery, and local software updates on the gateway via a LAN connection provided by the at least one LAN module.

8. The smart grid gateway of claim 1 wherein the smart grid gateway is configured to enable service personnel to run diagnostics, data recovery, and local software updates on the gateway via a WAN connection provided by the at least one WAN module

9. The smart grid gateway of claim 1 wherein the at least one metrology module is a replaceable component.

10. The smart grid gateway of claim 1 wherein the at least one LAN module is a replaceable component.

11. The smart grid gateway of claim 1 wherein the at least one WAN module is a replaceable component.

12. The smart grid gateway of claim 1 wherein the onboard computer is configured to additionally provide energy storage management, management of distributed generation assets, and management of network assets and resources.

13. The smart grid gateway of claim 1 wherein the onboard computer is configured to additionally provide energy storage management.

14. The smart grid gateway of claim 1 wherein the onboard computer is configured to additionally provide energy storage management, management of distributed generation assets.

15. The smart grid gateway of claim 1 wherein onboard computer is additionally configured to support residential metering.

16. The smart grid gateway of claim 1 wherein onboard computer is additionally configured to support commercial metering.

17. The smart grid gateway of claim 1 wherein onboard computer is additionally configured to support sub metering

18. The smart grid gateway of claim 1 wherein onboard computer is additionally configured to support demand management.

19. The smart grid gateway of claim 1 wherein onboard computer is additionally configured to support distributed generation management.

20. The smart grid gateway of claim 1 wherein onboard computer is additionally configured to support substation asset instrumentation with autonomous control.

21. The smart grid gateway of claim 1 wherein onboard computer is additionally configured to support substation asset instrumentation without autonomous control.

22. The smart grid gateway of claim 1 wherein onboard computer is additionally configured to support network asset instrumentation within context of a smart grid.

23. A smart grid management system comprising:
a plurality of intelligent network asset control systems connected to a network, each controlling at least one asset on a power grid;
a plurality of intelligent commercial building control systems connected to the network, each controlling at least one commercial building device connected to the power grid;
a plurality of intelligent residential control systems, each controlling at least one residential device connected to the power grid;
at least one utility operator console connected to the network, wherein the at least one utility operator console is configured to control the plurality of intelligent network asset control systems, the plurality of intelligent commercial building control systems, and the plurality of intelligent residential control systems, wherein a console operator is enabled to manage demand for power on the power grid.

24. The smart grid management system of claim 23 wherein at least some of the plurality of intelligent commercial building control systems, and at least some of the plurality of intelligent residential control systems transmit power consumption data to the at least one utility operator console, wherein the at least one utility operator console is further configured to display power consumption data to the console operator.
